(19) United States
(12) Patent Application Publication
(10) Pub. No.: US 2025/0262467 A1
(43) Pub. Date: Aug. 21, 2025

(54) FIRE HOSE SHOULDER SUPPORT ACCESSORY

(71) Applicants: Kevin Doyle Sellers, Wiggins, MS (US); Anthony Wade Harper, Belmont, MS (US)

(72) Inventors: Kevin Doyle Sellers, Wiggins, MS (US); Anthony Wade Harper, Belmont, MS (US)

(21) Appl. No.: 19/056,679

(22) Filed: Feb. 18, 2025

Related U.S. Application Data
(60) Provisional application No. 63/555,025, filed on Feb. 18, 2024.
(60) Provisional application No. 63/661,618, filed on Jun. 19, 2024.

(51) Int. Cl. A62C 33/04

(52) U.S. Cl. CPC A62C 33/04

(57) ABSTRACT

A fire hose shoulder support accessory, also called support accessory, having a forward support and a rear support is presented. The support accessory allows one person to safely handle a fire hose and nozzle under high pressure by having a nozzle holder incorporated in the forward support that is connected to a shoulder stock assembly (i.e., a rear support) using a coupling hub. The rear support has a connector part and a support part with the support part sized and shaped to rest against an individual's shoulder. The connector part may extend from and retract back into the support part adjusting the length of the support accessory. The support accessory may have one or more clamps that hold the fire hose and nozzle in the support accessory.

### CROSS-REFERENCE TO RELATED APPLICATIONS

This application claims priority to Provisional Application No. 63/555,025 filed Feb. 18, 2024 and Provisional Application No. 63/661,618 filed Jun. 19, 2024, with Provisional Application No. 63/555,025 and Provisional Application No. 63/661,618 incorporated in the current application.

### FEDERALLY SPONSORED RESEARCH

Not applicable.

### BACKGROUND OF THE INVENTION

The technical field of the invention relates to Fire Fighting Equipment, more specifically, Fire Hose Support Accessories. This Invention relates to an apparatus for supporting a fire hose when in operation, and more particularly to a nozzle holder coupled to a shoulder support assembly that makes it more secure and safer to handle for one person while discharging water at high pressure.

### BRIEF SUMMARY OF THE INVENTION

The nozzle end of the fire hose is very difficult and dangerous to handle especially in confined and low visibility conditions, which are often the case when fire fighting in buildings. To handle the hose safely it often requires several persons to support and brace the hose or the fireman in front. This invention, the Fire Hose Shoulder Support Accessory, also referred to as support accessory, allows one person to safely handle the hose and nozzle under high pressure by means of the nozzle holder incorporated in a forward support connected to a shoulder stock assembly (i.e., a rear support) using a coupling hub.

The novel design takes a shock load of a high-pressure nozzle and transfers it to the person's shoulder so if the person is positioned with feet spaced, preferably at least shoulder width apart, the person can take the load and stay on target without requiring another individual positioned behind them to brace the firefighter's body or handle the hose. This nozzle holder with the shoulder support assembly is anticipated to be constructed of lightweight materials to prevent any additional burden on the firefighter and for easy transporting with the hoses and other nozzles on the fire truck.

This invention as described is mainly for a pistol grip style nozzle with bail or trigger valve design. But other embodiments without a pistol grip may be accomplished with minor variations of the basic concept. The need for this invention is quite clear as it allows firefighters of different body sizes and physical strength to handle the high-pressure hose safely and more precisely in firefighting situations especially in confined spaces. It can be used in municipal as well as rural fire departments.

This apparatus is suitable for embodiments for nozzles and

hoses in sizes from 1″-2.5″ with 1.5 and 1.75 inches the most common, though the invention may be modified to accommodate hoses of other diameters if a need arises. The nozzle may be a pistol grip nozzle with bail or trigger valve.

The forward support may include a nozzle holder with clamps for securing the nozzle, and a coupling hub having a forward receiver or forward sleeve with coupling features to allow for the connection and fixing of a connector part of the rear support securely to the forward support. The forward receiver will have a one end, a forward receiver front end, from which a connector one end extends and is secured to the forward receiver. The coupling features may include one or more keys around a forward receiver other end, forward receiver rear end, of the forward receiver. The keys are sized and shaped to mate with key slots of the rear support aligning the forward support with the rear support. The nozzle holder and the coupling hub of the forward support may be made of a high temperature engineering polymer.

The rear support that may be an adjustable shoulder stock featuring a support part (i.e., shoulder stock or referred to a stock) and a connector part (i.e., aluminum stock tube with a machined rail). The support part may have a lever actuator/spring/lug mechanism to lock and unlock the connector part from the support part, allowing the connector part to move in and out of the support part adjusting the length of the support accessory. By providing for multiple length adjustments, the support accessory may accommodate different body sizes.

Also incorporated into or as a separate component fastened to a rear portion of support part may be a rest for the hose (i.e., a hose support) to keep the hose from falling off the shoulder of the fire fighter. The hose support may also have a clamp to hold the hose in the hose support. The hose support helps the fire fighter focus on the fire in front of them rather than the hose behind them.

Some embodiments may have a pad on a rear end of the support accessory (i.e., a rear end of the shoulder stock or stock) to cushion any shock load impacting the fire fighter's shoulder. Additionally, the stock may be curved to comfortably fit a user's shoulder.

A front lock and a rear lock, also referred to as a forward lock and a rear lock, respectively, that may be threaded lock rings, may be used to secure the connector part (e.g., an aluminum tube), of the rear support (i.e., stock assembly) to the forward support. The coupling hub may have a forward receiver with a forward receiver front end and a forward receiver rear end that may be recessed, a front recess and a rear recess, respectively, in the coupling hub. The front recess will ensure the proper surface for the front lock to mate with one end of the connector and the rear recess may allow for one or more keys around the forward receiver rear end. The one or more keys around the rear end of the forward receiver are sized and shaped to mate with key slots of the rear lock, holding the connector, correctly aligned, in the forward receiver. Once the connector is aligned in the forward receiver the front lock may be placed on the connector front end securing the rear support to the forward support. The front and rear locks may be threaded lock rings that may be of a common spanner wrench style or other similar style made of aluminum, high temperature polymer or steel. Typically, there are 1 3/16″-16 Castellated nuts or SAE threaded Castle Nuts that may be used to secure the connector (i.e., that may be an aluminum tube) to the connection hub of the forward support. In some embodiments the rear lock may be a fixed ring on the connector with key slots that match the keys located around the rear end of the forward receiver.

There may be a series of annular clamps that hold a pistol grip style nozzle in the main housing (i.e., the nozzle holder without the clamps) of the apparatus that allows it to act as one rigid body. The clamps may be of a common over center or toggle latch design or some other appropriate design for an easy to lock/unlock fastener. There may be a fastener first part that may be a stretchable cord with a loop on one end that loops over a fastener second part that extended from the main housing off the nozzle holder. There may be one or more shims that may or may not have a contact channel that allow the shims to cradle raised portions of the nozzle and the firehose. One or more of the shims may be adjustable allowing the adjustable shim to move across the clamp inner surface. One or more of the shims may have contact slots to cradle raised portions of the nozzle and the firehose. The shims may be made of flexible and semi-compressible materials allowing the shim to be shaped to conform to the clamp's inner surface and press against and cradle the nozzle and the firehose. The shims, coupled to one or more of the clamps, allow the support accessory to accommodate hoses and nozzles of varying dimensions.

### BRIEF DESCRIPTION OF THE SEVERAL VIEWS OF THE DRAWINGS

The accompanying drawings, which are incorporated in and form part of the specification, illustrate various examples of the present invention and, together with the detailed description, explain the principles of the invention.

FIG. 1 shows an unassembled view of the invention with a nozzle and fire hose the invention is intended to carry.

FIG. 2 shows an assembled view of the invention carrying a fire hose mated to a nozzle.

FIG. 3 shows another assembled view of the invention carrying a fire hose mated to a nozzle.

FIG. 4 an elevation view of the invention.

FIG. 5 a rear end elevation view of the invention.

FIG. 6 shows a frontal view of the invention.

FIG. 7 shows a sectional view along line 7-7 of FIG. 5.

FIG. 8 shows a top view of the invention

FIG. 9 shows an elevation view of the connector part of the invention.

FIG. 10 shows a sectional view of the connector part along line 10-10 for FIG. 9.

FIG. 11 shows a bottom view of the connector part.

FIG. 12A shows a side view of the connector part with a lockring.

FIG. 12B shows bottom view of the connector part with the lockring.

FIG. 13 shows a sectional view along line 13-13 of FIG. 12A.

FIG. 14 shows a side view of the invention with an adjustable shim on one clamp and an alternate shim on another clamp.

FIG. 15 shows a top view of the adjustable shim.

FIG. 16 shows a sectional view along line 16-16 of FIG. 15.

FIG. 17 shows a top view of another shim.

FIG. 18 shows a sectional view along line 18-18 of FIG. 17.

FIG. 19 shows a top view of yet another shim.

FIG. 20 shows a sectional view along line 19-19 of FIG. 19.

FIG. 21 shows a top view of the invention with alternate clamps with straps.

FIG. 22 shows an elevation view of the forward support with the alternate clamps without straps.

FIG. 23 shows a sectional view along line 23-23 of FIG. 22.

FIG. 23A shows an exploded view of FIG. 23.

FIG. 24 shows a sectional view along line 24-24 of FIG. 22.

### DETAILED DESCRIPTION OF THE INVENTION

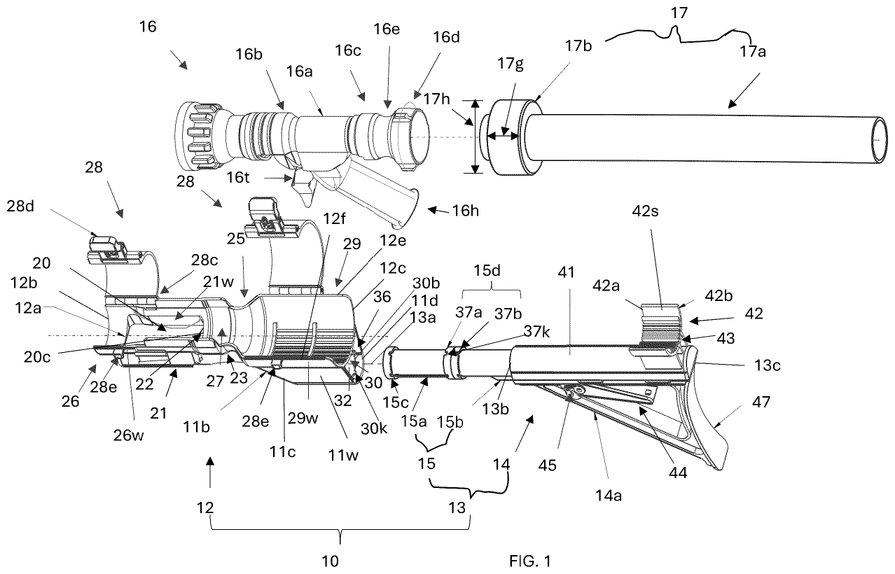

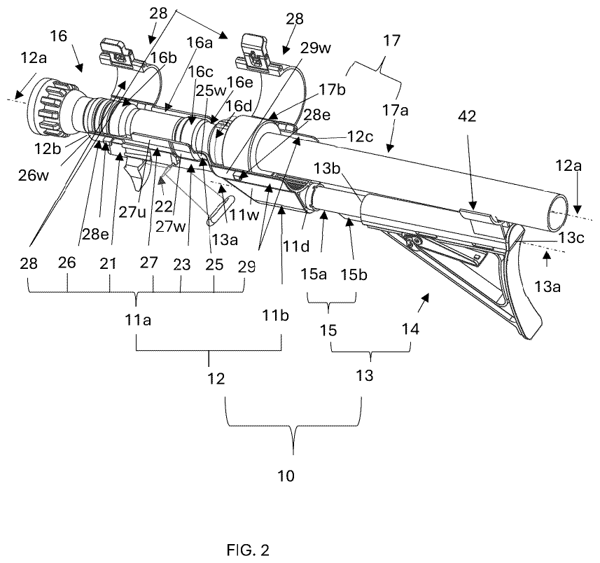

Referring to FIGS. 1, 2 and 3, the invention is a fire hose shoulder support accessory, hereafter referred to as a support accessory 10, having a forward support 12 and a rear support 13. The forward support 12 may have a forward support axis 12a, a forward support one end 12b that is also called a support accessory front end, and a forward support other end 12c, also called a support accessory rear end. The rear support 13 may have a rear support axis 13a, a rear support one end 13b, and a rear support other end 13c that may also be referred to as a support accessory rear end. Referring to FIG. 2, the forward support 12 may have a nozzle holder 11a and a coupling hub 11b having a coupling hub wall 11w, the coupling hub 11b used to join the rear support 13 to the forward support 12.

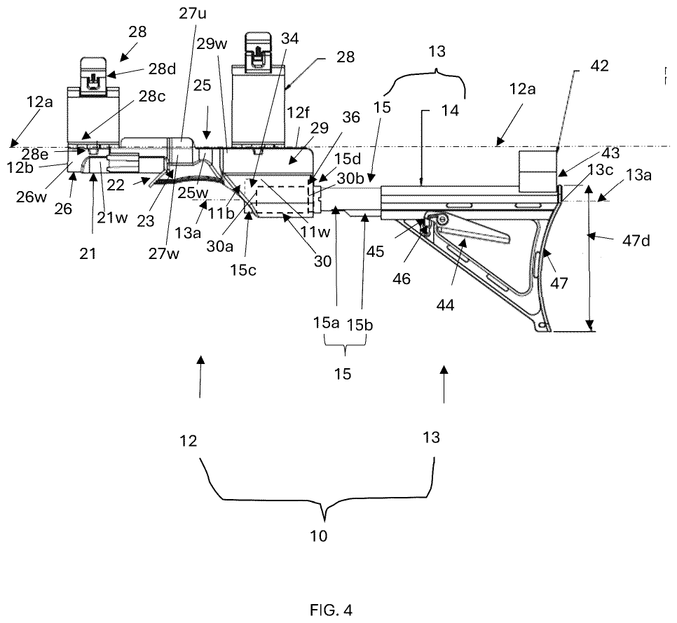

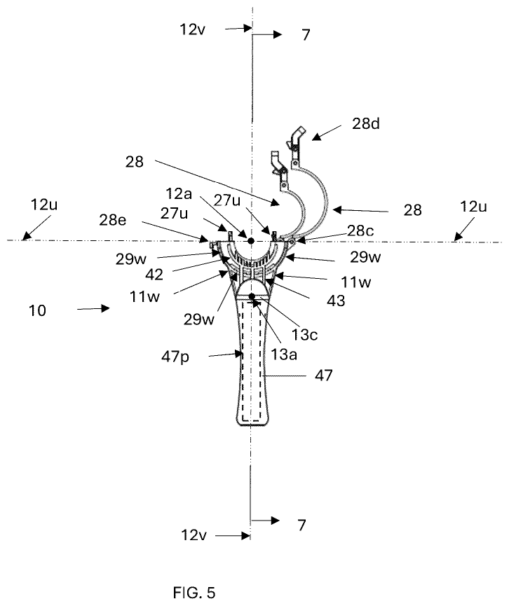

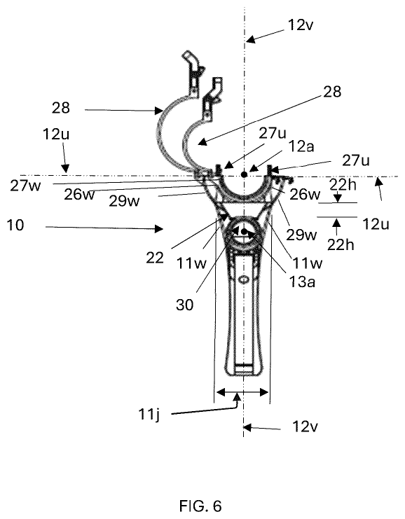

Referring to FIGS. 4, the forward support axis 12a and the rear support axis 13a may be in parallel with the forward support axis 12a in a reference horizontal plane 12u as shown in FIGS. 5 and 6, a rear and a front view, respectively, of the support accessory 10. Referring again to FIGS. 5 and 6, the forward support axis 12a and the rear support axis 13a may be in a vertical reference plane 12v that is perpendicular to reference horizontal plane 12u. Thus, when the accessory device is employed aimed with the forward support axis 12a and the rear support axis 13a horizontal, the forward support axis 12a would be above the rear support axis 13a. The rear support 13 may further have a support part 14 and a connector part 15 with the connector part 15 having a connector 15a and a rail 15b. There may be front lock 15c and a rear lock 15d on the connector 15a.

Referring again to FIGS. 1-4, the forward support 12 may be connected to the rear support 13 along the rear support axis 13a using the connector 15a and secured using the front lock 15c and the rear lock 15d. The support part 14 may be an adjustable stock from a rifle, such as an AR-15 rifle adjustable stock, available in the marketplace. The support part 14 may be sized and shaped to rest against an individual's shoulder. Although not shown, the support accessory 10 may be a single unit with the forward support 12 permanently attached to the rear support 13.

Continuing to refer to FIGS. 1 and 2, the support accessory 10 is sized and shaped to receive a nozzle 16 and a fire hose 17. The nozzle 16 may comprise: a trigger handle portion 16a located between a forward nozzle portion 16b and a rear nozzle portion 16c. The nozzle 16 may further comprise a nozzle hose connector portion 16d connected to the rear nozzle portion 16c using a transition portion 16e. The trigger handle portion 16a may have a handle 16h and a trigger 16t, although some nozzles may have a handle 16h without a trigger 16t. The fire hose 17 may have a hose portion 17a and a coupling portion 17b, with the coupling portion 17b sized and shaped to connect to the nozzle hose connector portion 16d of the nozzle 16. The coupling portion 17b may be a camlock coupling or a treaded coupling.

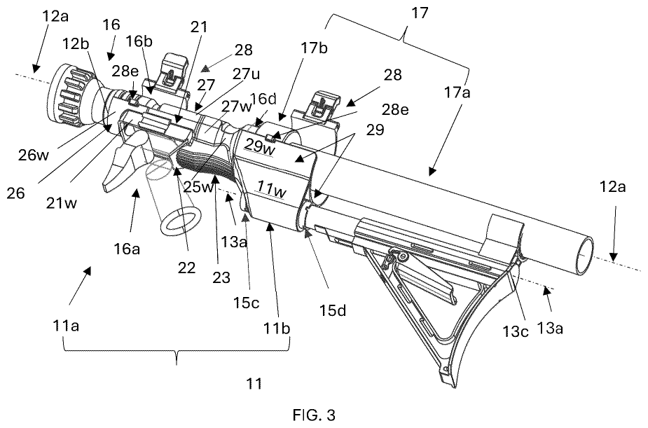

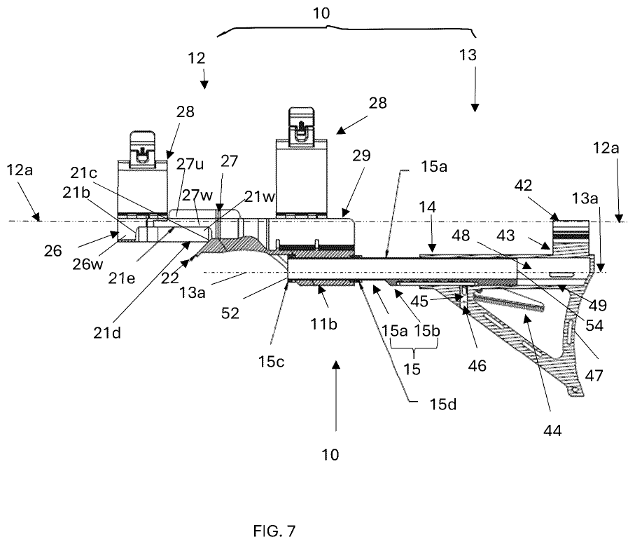

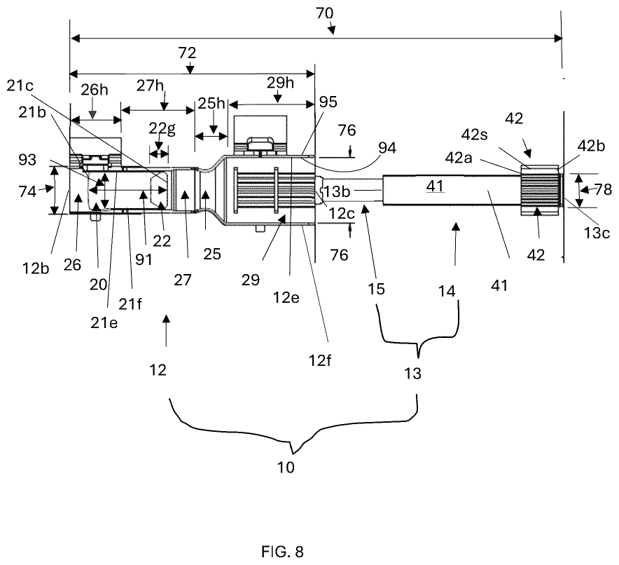

Referring to FIGS. 1-4, the nozzle holder 11a of the forward support 12 may have an aperture 20 and an abutment 22. Referring to FIG. 1 and FIG. 8, a top view of the support accessory 10, the aperture 20 may be located in an aperture portion 21 having an aperture wall 21w with and, referring to FIG. 7, aperture front edge 21b, an aperture rear edge 21c, an aperture lower edge 21d, and referring to FIG. 8, an aperture upper one side edge 21e and an aperture upper opposite side edge 21f. Referring to FIGS. 7 and 8, the abutment 22 may extend down from an aperture rear end 20c. The aperture 20 is sized and shaped accept at least the handle 16h of the nozzle 16 shown in FIG. 1. Referring again to FIGS. 7 and 8, the abutment 22 may extend down from the aperture lower edge 21d at the aperture rear edge 21c and may be sized and shaped to prevent the handle 16h moving toward the coupling hub 11b. The aperture lower edge 21d runs around the aperture wall 21w and may be parallel to the aperture upper one side edge 21e and the aperture upper opposite side edge 21f. In embodiments of the invention with a trigger 16t, the aperture 20 may be sized and shaped to accept both the handle 16h and the trigger 16t. Referring to FIG. 2, the nozzle holder 11a may further comprise: a forward nozzle support portion 26 having a forward nozzle support wall 26w, the forward nozzle support portion 26 sized and shaped to accept and cradle the forward nozzle portion 16b; a rear nozzle support portion 27 having a rear nozzle support extension wall 27u and a rear nozzle support wall 27w, the rear nozzle support portion 27 sized and shaped to accept and cradle the rear nozzle portion 16c and the trigger handle portion 16a; a transition support portion 25 having a transition support wall 25w, the transition support portion 25 sized and shaped to accept and cradle the transition portion 16e; a nozzle hose support portion 29 having a nozzle hose support wall 29w, the nozzle hose support portion 29 sized and shaped to accept and cradle the nozzle hose connector portion 16d coupled to the coupling portion 17b of the fire hose 17; an abutment portion 23 providing lateral support for the abutment 22 also shown in FIGS. 3 and 4, the abutment portion 23 may be located below the rear nozzle support wall 27w and the transition support wall 25w with the abutment 22 on one end of the abutment portion 23 and the coupling hub 11b located on an other end; and the nozzle holder further having one or more clamps 28 sized and shaped to hold the nozzle 16 in the nozzle holder 11a. The aperture portion 21 may extend from the forward nozzle support wall 26w and the rear nozzle support wall 27w with the transition support portion 25 positioned between the rear nozzle support portion 27 and the nozzle hose support portion 29.

Referring to FIGS. 1, 4-6, the coupling hub wall 11w extends from the nozzle hose support wall 29w around a forward receiver 30 and then connects again with the nozzle hose support wall 29w. Continuing to refer to FIGS. 4, 5, and 6, the rear nozzle support extension wall 27u extends above the forward support axis 12a from the rear nozzle support wall 27w. The forward nozzle support wall 26w, the rear nozzle support wall 27w, and the nozzle hose support wall 29w and the transition support wall 25w may extend from the reference horizontal plane 12u on one side of the support accessory 10 in a semicircular manner to the reference horizontal plane 12u on an opposite side of the support accessory 10.

Referring to FIG. 1, there may be a clamp 28 that is be sized and shaped to mate with the forward nozzle support portion 26 to hold the forward nozzle portion 16b of the nozzle 16 in the forward nozzle support portion 26. There may be another clamp 28 sized and shaped to mate with the nozzle hose support portion 29 sized and shaped to hold the nozzle hose connector portion 16d of the nozzle connected to the coupling portion 17b of the fire hose 17 in the nozzle hose support portion 29 of the forward support 12. Referring to FIGS. 1-2, the rear support 13 may have a hose support 42, sized and shaped to cradle the hose portion 17a of the fire hose 17. The clamps 28 may be semi cylindrical. Referring to FIGS. 1 4, one or more of the clamps 28 may have a hinged connection 28c similar to a house door hinge, allowing the clamps 28 to be placed over the nozzle 16 and the coupling portion 17b of fire hose 17 securing them in the forward support 12 using a fastener first part 28d attached to each of the clamps 28, and a fastener second part 28e that may extend outward from each of the forward nozzle support wall 26w and the nozzle hose support wall 29w.

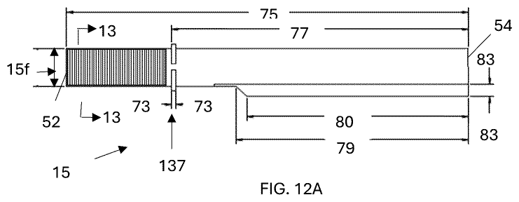

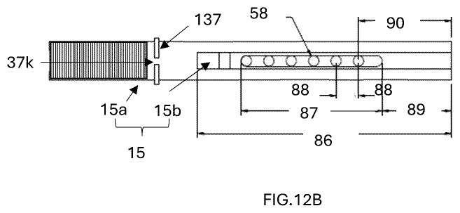

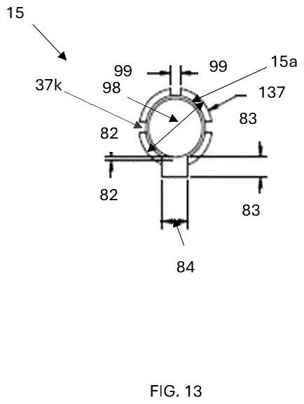

Referring to FIGS. 1 and 4, the forward receiver 30 is sized and shaped to receive the connector 15a of the rear support 13. The coupling hub 11b may have the forward receiver 30 that may have a forward receiver inner wall 32 that may be cylindrical, and there may be at a forward receiver one end, also called a forward receiver front end 30a, a forward recess 34 in the coupling hub 11b sized and shaped and sized for a front lock 15c, and at a forward receiver opposite end, also called a forward receiver rear end 30b, there may be a rear recess 36 sized and shaped and sized for a rear lock 15d. The front lock 15c and the rear lock 15d will be sized and shaped to hold the connector 15a of the rear support 13 in the forward receiver 30. The forward recess 34 and the rear recess 36 may be ¼ inch greater than the diameter of the front lock 15c and the rear lock 15d, respectively. The forward sleeve or forward receiver 30 may have a diameter that is at least 1/16 inch greater than a connecter radius as measured perpendicular to the rear support axis 13a. The front lock 15c and the rear lock 15d may be threaded nuts and may have key slots 37k. Referring to FIG. 1, the forward receiver 30, also called the forward sleeve may have one or more keys 30k on the opposite end of the forward receiver, the forward receiver rear end 30b, that are sized and shaped to fit the key slots 37k of the rear lock 15d. The rear lock 15d may be two lock nuts, one against the other, with at least one positioned with the key slots 37k to mate with the keys 30k of the forward receiver 30. With the front lock 15c removed from the connector 15a, the connector 15a may be inserted through the forward receiver 30 and the front lock 15c used to hold the connector 15a in the coupling hub 11b. The forward nut 37a of the rear lock 15d, shown in FIG. 1, is then moved toward the forward receiver 30 and rotated to align and place the key slots 37k on the keys 30k of the forward receiver 30. The rear nut 37b, shown in FIG. 1, of the rear lock 15d is then rotated forward and tightened against the forward nut 37a establishing the alignment of the forward support 12 and the rear support 13. The front lock 15c is then placed on the connector 15a and tightened securing the connector 15a in the forward receiver 30. Referring to FIGS. 12A, 12B, and 13, in embodiments of the invention having a lock ring 137 on the connector 15a, the connector 15a is rotated to align and place the key slots 37k on the keys 30k of the forward receiver 30 and then the front lock 15c is placed on the connector 15a and tightened. The connector part 15 may be a made with aluminum, steel, polymer, titanium, or other suitable material. The connector 15a may be a stock tube with the rail 15b that may be machined.

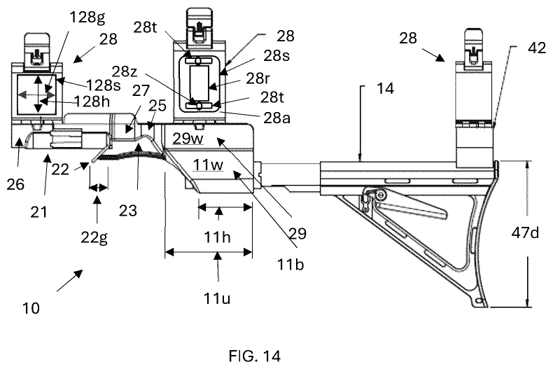

The support part 14 may be similar to an AR-15 adjustable stock and may be made of wood, aluminum, steel, polymer, titanium, plastic, other suitable material or a combination thereof. Referring to FIG. 1, the support part 14 may have a stock top surface 41 with a hose support 42 mounted to the stock top surface 41 using one or more legs 43. There may be three of the legs 43 and each leg 43 may be a rectanguloid. The hose support 42 will be sized and sized and shaped to hold the fire hose 17. The hose support 42 may be semicylindrical and may be a half of an open cylinder with a support radius that may be 0.125-0.500 inches, preferably 0.5 inches greater than the radius of the fire hose 17. The hose support 42 may have a hose support surface 42s and a hose support one end 42a and a hose support other end 42b. Referring to FIG. 14, there may be yet another clamp 28 sized and shaped to mate with the hose support 42 of the rear support 13 to hold the hose portion 17a of the fire hose 17 in FIG. 1 in the hose support 42.

Referring to FIG. 8, the hose support surface 42s may further have one or more ribs 42r running from the hose support one end 42a to a hose support other end 42b, the ribs 42r may have a semicircular cross section with a radius of 0.125 to 0.25 inches a measured in planes perpendicular to the hose support surface 42s.

Referring to FIG. 4, the support part 14 of the rear support 13 may further have a lever 44 that moves a locking pin 45 on a spring 46 allowing the locking pin 45 to lock and unlock the connector part 15 in a support part 14. Referring to FIG. 7, the support part 14 may have the stock connector sleeve 48 and a rail channel 49 sized and shaped to receive the connector 15a and the rail 15b, respectively. The support part 14 part may have a shoulder end 47, allowing the support part 14 to be placed against an individual's shoulder. Referring to FIG. 5, there may be a pad 47p attached to the shoulder end 47 to cushion the rearward force due to water exiting the nozzle 16 shown in FIGS. 1-3.

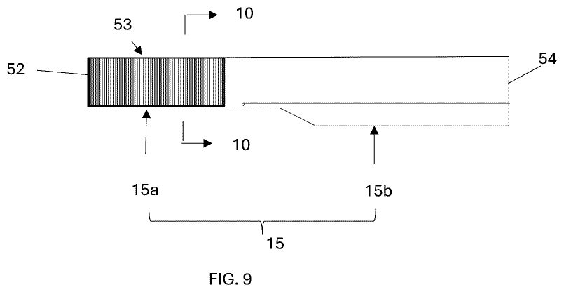

Continuing to refer to FIGS. 7, and 9-13 the connector 15a may have a connector one end 52 with threads 53, and a connector other end 54. The connector one end 52 is sized and shaped to be inserted in the coupling hub 11b and the threads 53 mated with the front lock 15c allowing the connector 15a to be held in the coupling hub 11b. The connector other end 54 is sized and shaped to move back-and-forth in the stock connector sleeve 48 allowing the length of the support accessory 10 to be variable and adjusted using the lever 44 to remove and reinsert the locking pin 45 in the rail 15b. Referring to FIGS. 7, and 11 and 12B, the locking pin 45 of FIG. 7 is sized and shaped to be inserted in connector pockets 58 of the rail 15b. Referring to FIGS. 12A, 12B, and 13, in another embodiment the rear lock, the lock ring 137 is attached to the connector 15a with the lock ring 137 having one or more of the key slots 37k sized and shaped to fit the keys 30k at the forward receiver rear end 30b of FIG. 1.

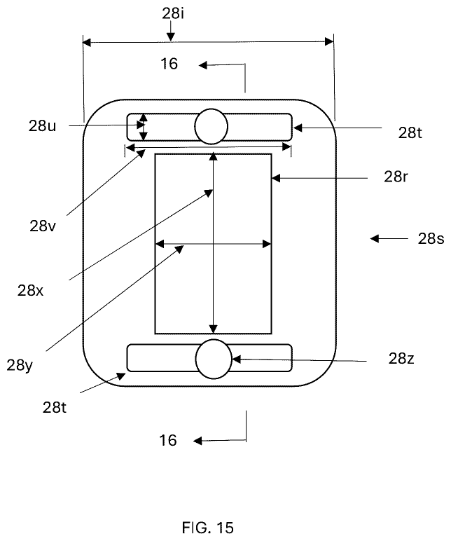

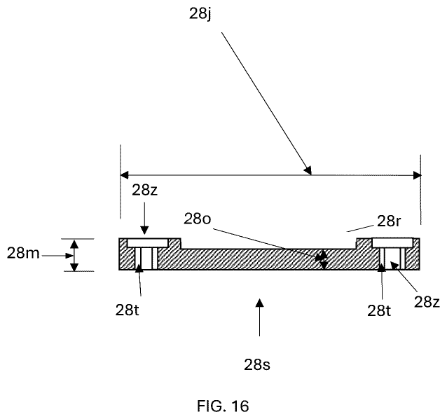

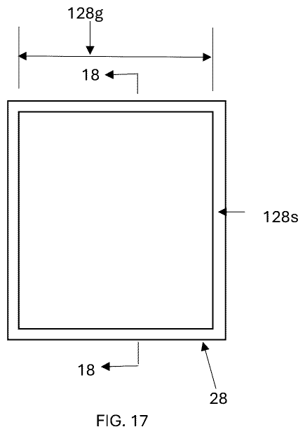

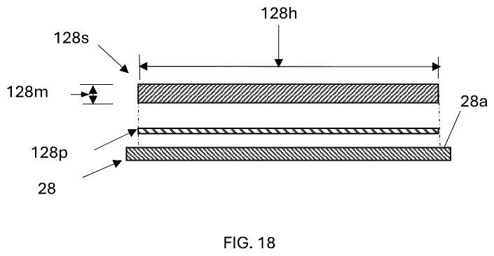

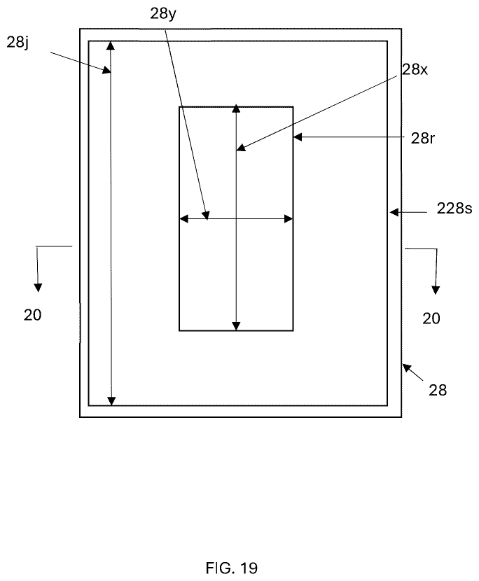

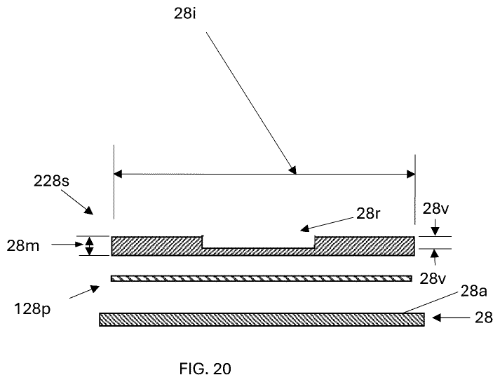

Referring to FIGS. 1 and 14, there may be an adjustable shim 28s may be provided so that the support accessory 10 may accept fire hoses 17 of FIG. 1 with hose portions 17a and coupling portions 17b of varying sizes. The adjustable shim 28s may be applied to the clamp inner surface 28a of the clamps 28 and held in place with one or more shim fasteners 28z. The adjustable shim 28s may be made of flexible material or a semi-compressible and flexible material that allows the adjustable shim 28s to conform to shape of the clamps 28. The adjustable shim 28s may move in shim slots 28t that allow the adjustable shim 28s to move parallel to the forward support axis 12a shown in FIG. 1 adjusting the adjustable shim 28s to the location of the coupling portion 17b. The adjustable shim 28s may have a contact channel sized for the coupling portion 17b of the fire hose 17 shown in FIG. 1, allowing the shim 28s to accept and cradle the coupling portion 17b. Referring to FIGS. 15, an exploded view of the adjustable shim 28s is shown with a sectional view along line 16-16 is shown in FIG. 16. The adjustable shim 28s may have shim thickness 28m from 0.125-0.250 inch preferably 0.190 inches. Referring again to FIG. 14, an alternate shim 128s may be applied to the clamp 28 at the forward support one end 12b. Looking to FIG. 17 an enlarged view of the alternate shim 128s, the alternate shim 128s may have an alternate shim width 128g between 1-3 inches, preferably 1.5 inches, and referring to FIG. 18, a sectional view of the alternate shim 128s along line 18-18a, the alternate shim may have an alternate shim height 128h between 1-4 inches, preferably 2 inches with aa alternate shim thickness 128m from 0.125-0.250 inch preferably 0.190 inches. The alternate shim 128s may be attached to the clamp 28 to using an adhesive 128p. Referring to FIG. 19, yet another shim 228s is shown having the contact or coupling channel 28r. Referring to FIG. 20, the yet another shim 228s may fastened to the clamp inner surface 28a using an adhesive 128p.

Referring to FIG. 1, the fastener first part 28d may be stretchable with a loop sized and shaped to fit over the fastener second part 28e.

Referring to FIGS. 1, 4 and FIG. 8 the nozzle hose support portion 29 may have nozzle hose support wall 29w the is generally semi-cylindrical with a forward support one side edge 12e that is opposite a forward support other side edge 12f. One of the clamps 28 may be attached to the forward support one side edge 12e and connected to the fastener second part 28e at the forward support other side edge 12f of the nozzle hose support portion 29. The forward nozzle support portion 26 may have a forward nozzle support wall 26w that is substantially semi cylindrical and disposed to cradle the forward nozzle portion 16b. Another of the clamps 28 may be attached to the forward support one side edge 12e of the forward nozzle support portion 26 and the other clamp 28 fastened to the fastener second part 28e at the forward support other side edge 12f of the forward nozzle support portion 26. The nozzle holder 11a may extend from a forward support one end 12b along a forward support one side edge 12e and a forward support one side edge 12e to a forward support other end 12c. The coupling hub 11b may have a coupling hub wall 11w that extends from a hub one end 11c to a hub other end 11d. Referring to FIG. 6, the coupling hub wall 11w that may extend from the nozzle hose support wall 29w on one side of the support accessory 10 and continue around the forward receiver 30 and connect back to the nozzle hose support wall 29w on the other side of the support accessory 10. Referring to FIGS. 1, 2, and 6, the rear nozzle support wall 27w may be semi-circular extending from a reference horizontal plane 12u and a rear nozzle support extension wall 27u on one side of the support accessory 10 to another rear nozzle support extension wall 27u on the other side of the support accessory 10.

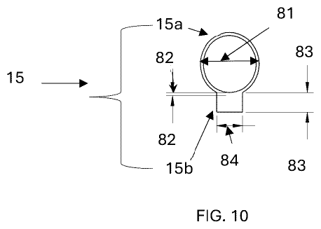

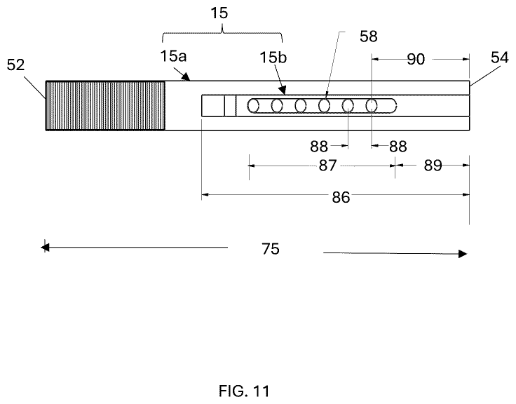

Referring to FIG. 4, the support accessory 10 may have a stock height 47d of 7.48 inches. Referring to FIG. 8, the support accessory 10 may have: a support accessory length 70 that is variable ranging from 22 to 27.750 inches; a forward support length 72 of 12.625 inches; a forward nozzle support width 74 of 2.450 inches; a nozzle hose support width 76 of 0.1 to 0.25 inches greater than the coupler diameter 17h; a support part width 78 of 0.1-0.25 inches, preferably 0.20 inches; a nozzle holder wall thickness' as measured from the nozzle hose support inner wall surface 94 to the nozzle hose support outer wall surface 95 of 0.125 inches; an aperture length 91 of 4.00 inches and an aperture width 93 of 2.000 inches; an abutment length equal to the aperture width 93 of 2.000 inches; an abutment base 22g of 0.750 inches, and referring to FIG. 5, an abutment height 22h of 1-1.5 inches; referring again to FIG. 8, a forward nozzle support length 26h of 2.6875 inches, a rear nozzle support width that may be equal to the forward nozzle support width 74 of 2.45 inches and a rear nozzle support length 27h of 3.875 inches; a transition support portion width 25g of 1-2 inches and a transition support portion length 25h of 1.375 inches, a nozzle hose support width 76 of 3.34 inches, referring to FIG. 14, a coupling hub upper length 11u equal to the nozzle hose support length 29h and a coupling hub top width 11g of 1-3 inches, a coupling hub lower length 11h of 1-2 inches and a coupling hub top width 11j of 1.625 inches, a clamp width 28g of 1-2 inches and a clamp length 28h of half the circumference of that portion of the nozzle holder 11a covered by the clamp 28. Referring to FIG. 10, the connector part 15 may have a connector outer diameter 81 of 1.150 inches, a connector wall thickness 82 of 0.060 inches, and a rail height 83 of 0.357 inches and a rail width 84 of 0.500 inches. Referring to FIG. 11, the connector may have a connector length 75 of 12.1 inches, a rail length 86 of 7.650 inches, a rail recess length 87 of 4.250 inches, a rail recess rear position 89 of 0.209 inches, with the connector pocket separation distance 88 of 0.675 inches, and a rail recess rear distance 90 that may be 2.580 inches from the connector other end 54. Referring to FIG. 12A, the connector 15a may have a connector diameter 15f of 1.150 inches, a connector length 75 of 12.100 inches, a lockring forward distance 77 of 8.939 inches, a lockring thickness 73 of 0.130 inches, rail upper slant distance 79 of 7.000 inches, and a rail lower slant distance 80 of 6.740 inches. Referring to FIG. 13, the lock ring 137 may have a lockring diameter 98 of 1.407 inches, and one or more key slots 37k that may have a key width 99 of 0.0.200 inches. Referring to FIGS. 14 16, the adjustable shim 28s may have a shim-width 28i of at least 0.250 inches greater than the coupling portion width 17g and less than the clamp width 28g, a shim length of 28j that may be less than half the circumference of the coupling portion 17b calculated using the coupling diameter 17d but at least the coupling diameter 17d, a shim thickness 28m of at least 0.125 inches and a shim slot-thickness 280 of at least 0.0625 inches, a contact channel-length 28x of at least 1.0 inch, a contact channel-width 28y of at least the 0.0325 inches, a shim traverse-slot-length 28v of 0.0125 less the shim-width 28i, a shim traverse slot width 28u of 0.0325 greater than a diameter the shim fastener 28z. The shim fastener 28z being a bolt between 0.125 and 0.250 inches in diameter, preferably 0.1875 in diameter. The head of the shim fastener 28z may be recessed in the adjustable shim 28s no greater than one tenth of the shim thickness 28m. The shim traverse slot 28t shall be at least 0.125 inches from the contact channel 28r. Referring again to FIG. 14, the coupling hub 11b may a coupling hub upper length 11u equal to the nozzle hose support length 29h, and a coupling hub lower length 11h that may be one half to two thirds of the coupling hub upper length 11u, or referring to FIG. 12A, FIG. 12B, and FIG. 13, for a connector with a lock ring 137 and a threaded the connector one end 52, the distance from the connector one end 52 to the lock ring 137 minus ½ inch allowing for threads for the front lock 15c to be placed on the connector one end 52. The coupling hub one end 11c may be 45 degrees measured clockwise with another horizontal plane parallel that is parallel to the reference horizontal plane 12u. The abutment 22 may have an abutment base 22g that is 0.7-2.0 inches, one example may be 0.75 inches, and referring to FIG. 6, an abutment height 22h of 1-1.5 inches.

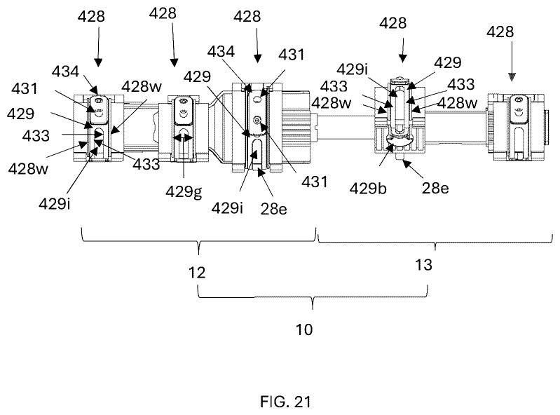

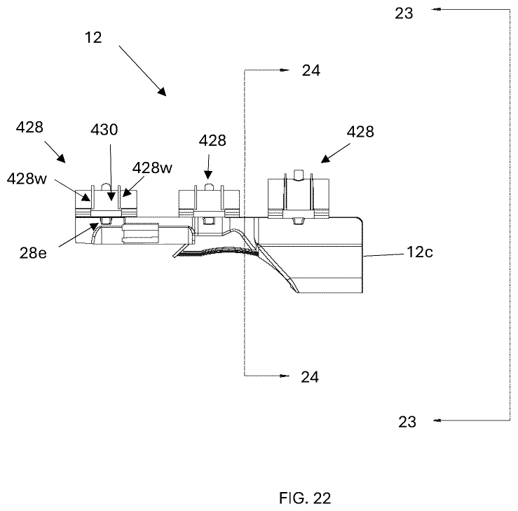

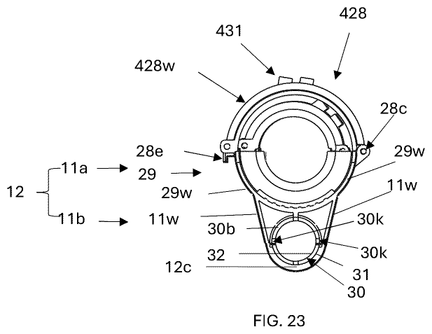

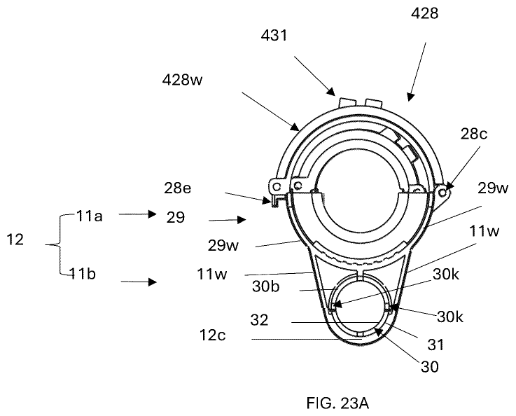

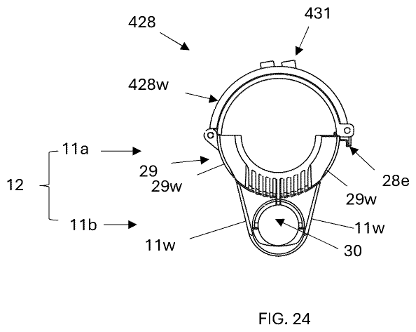

Referring to FIG. 21, shown is a top view of the support accessory with 5 alternate clamps 428, with 3 of the alternate clamps 428 on the forward support 12, and a rear support 13 with 2 hose supports 42, each with the alternate clamps 428. Referring to FIG. 22, show is an elevation view of the forward support 12 with the 3 alternate clamps 428. FIG. 23 is a rear end view of the forward support 12.8 and FIG. 23A is an exploded view of the forward support other end 12c. Referring again to FIG. 22 and FIG. 24, a sectional view along line 24-24 of FIG. 22, each of the alternate clamps 428 may have two track walls 428w that are substantially parallel to each other with a track 430 there between. The track walls 428w are may be 0.125 inches in wide and 0.125 to 0.250 high. Referring again to FIG. 21, a strap 429 may be may disposed between the track walls 428w and the strap 429 secured to the alternate clamp 428 using a top plate 434 and one or more strap fasteners 431. The strap fastener 431 may be treaded bolts 0.125 to 0,375 inches in diameter. The strap 429 may have a strap width 429g of 0.9375 inches and a strap length at least three quarters a circumference of the alternate clamp 428 that is substantially semicircular. The strap 429 may have a strap slot 429i surrounded by a strap side wall 433. Each of the straps 429 may have a strap slot width of 0.4375 inches as measured across the strap slot 429i perpendicular to the track walls 428w. The straps 429 may be stretchable and have a strap business end 429b that may be “T” shaped, allowing the user to pull the strap business end 429b until the strap slot 429i is over the fastener second part 28e. Referring to FIG. 23, the fastener second part 28e may be substantially “L” shaped, and referring again to FIG. 21, the strap business end 429b may to looped over the fastener second part 28e as shown for the alternate clamps 428 of the forward support 12. The adjustable shim 28s, the alternate shim 128s, and the yet another shim 228s shown in FIG. 14 may be used on each of the alternate clamps 428 of FIG. 21.

Referring to FIG. 23 and FIG. 23A, there are 4 keys 30k around the coupling receiver rear end 30b of the forward receiver 30. The forward receiver 30 have a forward receiver outer wall 31 and the forward receiver inner wall 32 with the forward receiver 30 disposed between a “U” shaped coupling hub wall 11w that extends from the nozzle hose support wall 29w.

Although the invention has been described with reference to one or more embodiments, this description is not meant to be construed in a limiting sense. Various modifications of the disclosed embodiments as well as alternative embodiments of the invention will become apparent to persons skilled in the art. It is therefore contemplated that the appended claims will cover any such modification or embodiments that fall within the scope of the invention.

1: A support accessory comprising: a forward support, and a rear support; the rear support comprising, a connector part, and a support part; the connector part connecting the forward support to the rear support; the forward support comprising a nozzle holder; and the nozzle holder to receive and hold a nozzle connected to a fire hose.

2: The support accessory of claim 1 wherein the nozzle holder further comprises an aperture portion, the aperture portion sized and structured to receive at least a handle of the nozzle.

3: The support accessory of claim 2 wherein the nozzle holder further comprises an abutment, the abutment disposed to rest against the handle of the nozzle.

4: The support accessory of claim 1 wherein the nozzle holder further comprises one or more clamps, disposed to hold the nozzle connected to the fire hose in the nozzle holder.

5: The support accessory of claim 4 wherein the forward support further comprises a coupling hub, the coupling hub disposed to receive the connector part of the rear support.

6: The support accessory of claim 5 wherein the connector part further comprises a front lock and a rear lock, the front lock and the rear lock disposed to hold the connector part in the coupling hub.

7: The support accessory of claim 6 wherein at least one of the one or more clamps further comprise one or more shims placed on a clamp inner surface.

8: The support accessory of claim 7 wherein at least one of the one or more shims has shim slots.

9: The support accessory of claim 7 wherein at least one of the one or more shims has a coupling channel.

10: The support accessory of claim 7 wherein at least one of the one or more shims has a coupling channel and two shim slots.

11: The support accessory of claim 10 wherein the rear support further comprising a hose support, the hose support disposed to cradle a hose portion of the fire hose.

12: The support accessory of claim 11 wherein a support accessory length is variable.

13: A support accessory comprising: a forward support, and a rear support; the rear support comprising, a connector part and a support part; the support part sized and shaped to rest against an individual's shoulder; the connector part connecting the forward support to the rear support; the forward support comprising a nozzle holder; the nozzle holder sized and disposed to receive and hold a nozzle connected to a fire hose; and the support accessory having a support accessory length that is variable.

14: The support accessory of claim 13 wherein the nozzle holder further comprises an aperture portion, the aperture portion disposed to receive at least a trigger and a handle of the nozzle; and an aperture in an aperture portion of the nozzle holder.

15: The support accessory of claim 14 wherein the nozzle holder further comprises an abutment, the abutment disposed to rest against the handle of the nozzle when the handle disposed through the aperture.

16: The support accessory of claim 15 wherein the nozzle holder further comprises one or more clamps, the clamps disposed to hold the nozzle in the nozzle holder.

17: The support accessory of claim 16 wherein the forward support further comprises a coupling hub, the coupling hub sized and disposed to receive the connector part of the rear support.

18: The support accessory of claim 17 wherein the connector part further comprises a forward lock and a rear lock, the forward lock and the rear lock disposed to hold the connector part to the coupling hub.

19: The support accessory of claim 18 wherein at least one of the one or more clamps further comprise a shim, the shim disposed on a clamp inner surface.

20: The support accessory of claim 19 wherein the shim has a coupling channel, the coupling channel disposed to cradle a coupling portion of the fire hose.

21: A support accessory comprising: a forward support and a rear support; the forward support comprising a nozzle holder; and the nozzle holder disposed to receive a nozzle connected to a fire hose.

22: The support accessory of claim 21 further comprising one or more clamps disposed to hold the nozzle connected to the fire hose in the support accessory.

23: The support accessory of claim 22 wherein at least one of the one or more clamps further comprises one or more shims.

24: The support accessory of claim 23 wherein at least one of the one or more shims has one or more shim slots.

25: The support accessory of claim 23 wherein at least one of the one or more shims has a coupling channel.

26: The support accessory of claim 23 wherein at least one of the one or more shims has two shim slots and a coupling channel.
